(19) United States
(12) Patent Application Publication
(10) Pub. No.: US 2026/0245846 A1
(43) Pub. Date: Aug. 20, 2026

(54) PUMPING SYSTEM INCLUDING AN ION PUMP AND METHOD FOR OPERATING A PUMPING SYSTEM INCLUDING AN ION PUMP

(71) Applicant: Agilent Technologies, Inc., Santa Clara, CA (US)

(72) Inventors: Andrea Bertallot, Cavour Torino (IT); Riccardo Garzella, Torino (IT); Giuseppe De Palma, Torino (IT); Paolo Manassero, Torino (IT); Tiziano Isoardi, Torino (IT)

(21) Appl. No.: 19/546,149

(22) Filed: Feb. 20, 2026

(30) Foreign Application Priority Data
Feb. 20, 2025 (GB) 2502476.1

(51) Int. Cl. H01J 41/12

(52) U.S. Cl. CPC H01J 41/12

(57) ABSTRACT

A pumping system includes an ion pump in which the pressure inside the ion pump can be more precisely determined. The ion pump includes a first electrode and a second electrode, and a controller unit for selectively applying either a first voltage having a first polarity between the first electrode and the second electrode or a second voltage having a second polarity, opposed to the first polarity, between the first electrode and the second electrode. By measuring the overall current supplied to the pump while the first voltage is applied and while the second voltage is applied, an operating current contributing to the pumping effect and a leakage current can be individually obtained, so that the pressure can be calculated starting from the operating current only.

### CROSS-REFERENCE TO RELATED APPLICATIONS

This application claims priority to UK Application No. GB2502476.1, filed February 20, 2025, the entire contents of which are incorporated herein by reference.

### TECHNICAL FIELD

The present disclosure relates to a pumping system including an ion pump. More in detail, the present disclosure relates to a pumping system in which the pressure (i.e. the vacuum level) inside the ion pump can be more precisely determined. The present disclosure also relates to a method for operating a pumping system including an ion pump, allowing to more precisely determine the pressure (i.e. the vacuum level) inside the ion pump.

### BACKGROUND

A sputter ion pump is a capture vacuum pump which operates by sputtering a getter material. A sputter ion pump is able to create and maintain high-vacuum conditions within a confined environment. More particularly, ion pumps are commonly used in ultra-high vacuum (UHV) systems, because they can reach pressures lower than 10⁻¹¹ mbar. Nowadays, the most common design of sputter ion pumps is based on the provision of one or more Penning cells, also known as Penning “traps”. The operation of the Penning trap is based on the confinement of free charged particles using an electrostatic-multipolar field combined with a magnetic-dipolar field. The magnetic field confines the particles radially, while the electrostatic field confines them in the axial direction.

Accordingly, as shown in FIG. 1, the basic structure of a Penning trap 1 includes a first electrode 5, a second electrode 3, and magnets (not shown). The first electrode 5 includes a pair of plates which are arranged parallel to each other and at a distance from each other. The second electrode 3 is made as a cell, for instance as a cylindrical cell with its longitudinal axis arranged perpendicular to the first electrode plates. A pair of magnets are placed on opposite sides of the Penning trap 1, externally to the first electrode plates and preferably outside the confined environment housing the first and second electrodes 5,3. If a voltage (typically from 3 to 9 kV) between the electrodes 5,3 is applied, an intense electric field is generated between the electrodes 5,3. The electric field, combined with the magnetic field generated by the magnets, allows to confine (i.e., to trap) the charged particles, thereby creating a non-neutral plasma.

As will be explained in detail below, in order to have the Penning trap 1 operating as an ion pump, an electron plasma is needed. In other words, the Penning cell 1 needs to work so as to “trap” electrons. In order to obtain an electron plasma, the two plates of the first electrode 5 need to serve as a cathode 5 (i.e., electrode at lower potential) and the cell of the second electrode 3 needs to serve as an anode 3 (i.e., electrode at higher potential). Therefore, a voltage (typically from 3 to 9 kV) between the cathode and the anode is applied and an intense electric field is generated, this resulting in the generation of an electric discharge. The electric field, combined with the magnetic field generated by the magnets, allows to confine (i.e., to trap) the electrons, thereby creating an electron plasma that is used to ionize the gas molecules present within the environment to be evacuated, namely within the anode cell.

In detail, the plasma electrons collide with the molecules in the anode cell, thereby ionizing them. Because of the electric field, the positive ions resulting from the ionization are attracted towards the cathode 5, leaving the corresponding electrons, left in the anode cell, available for further ionization of the other gas molecules. In this respect, the presence of the magnets for generating the magnetic field allows to impart helical trajectories to electrons, thereby increasing the length of the paths of such electrons between the cathode 5 and the anode 3 and, therefore, the possibility of collision and corresponding ionization of the gas molecules present within the environment. Positive ions, meanwhile, reach the cathode 5 and collide with the surface of the cathode 5. The collision of positive ions with the cathode 5, which is made of a getter material (for instance, titanium) causes the phenomenon of sputtering, i.e., the emission of getter material atoms from the cathode 5. The atoms, by covering the inner surfaces of the Penning trap 1, create an active film (so-called getter film) which chemically traps the gas molecules, which are therefore buried in the anode. This mechanism is termed pumping at the anode or getter pumping.

As mentioned above, ion pumps can reach very low pressures, lower than 10⁻¹¹ mbar. The pressure inside the sputter ion pump is a function of the ion pump structure, the voltage applied between the electrodes 5,3 and the current absorbed by the ion pump. Accordingly, with the ion pump structure and the applied voltage being known, the pressure (i.e. the vacuum level) attained by the ion pump is usually measured by measuring the current supplied to the ion pump and by calculating the pressure starting from the measured current.

However, the Applicant found out that the current supplied to the ion pump and measured is not entirely available for the pumping mechanism. Instead, the current supplied to the ion pump includes two fractions, namely an operating fraction or operating current, which contributes to the pumping effect, and a leakage fraction or leakage current, which is dispersed in the pumping system components (such as the controller, the electrical cables and connectors and the ion pump itself) and does not contribute to the pumping effect. Since the pressure inside the ion pump is a function of the operating current while the measured current is the overall current supplied to the ion pump, an inaccurate calculation of the pressure is obtained. In addition, the leakage current strongly depends on the environmental operating conditions and on the operating state of the ion pump (state of wear, possible malfunctioning, and the like), so that it cannot be determined during a calibration procedure of the sputter ion pump.

In view of the above, there may be a need to provide a pumping system including an ion pump in which the pressure or vacuum level inside the sputter ion pump can be more accurately determined. There may also be a need to provide a method of operating a pumping system including an ion pump allowing to more accurately determine the pressure or vacuum level inside the ion pump. These and other needs may be addressed by the pumping system and the corresponding operating method as described herein.

### SUMMARY

As mentioned above, in current arrangements the determination of the pressure is inaccurate because the pressure inside the ion pump is a function of the operating current while the measured current is an overall current supplied to the ion pump, including both the operating current and a leakage current. The present disclosure therefore relies upon the assumption that, if it were possible to isolate the operating current, such operating current could be used for calculating the pressure and a more accurate result could be obtained.

According to the present disclosure, a possible way of isolating the operating current is determining the leakage current. The leakage current is absorbed by the pumping system components both when the ion pump is in an operating mode and when the ion pump is in a non-operating mode.

As mentioned above, the ion pump is in an operating mode only when an electron plasma is generated, i.e., when a voltage with the right polarity is applied between a first electrode and a second electrode of the ion pump.

Accordingly, the pumping system according to embodiments of the present disclosure includes an ion pump, comprising a first electrode and a second electrode, and a controller unit for applying a voltage between the first electrode and the second electrode, and the controller unit is configured for selectively applying either a first voltage having a first polarity between the first electrode and the second electrode or a second voltage having a second polarity, opposed to the first polarity, between the first electrode and the second electrode.

In an embodiment, the controller unit comprises a piloting unit for selectively applying either a first voltage having a first polarity between the first electrode and the second electrode or a second voltage having a second polarity, opposed to the first polarity, between the first electrode and the second electrode.

In an embodiment, the pumping system further comprises a current sensor suitable for detecting the current supplied to the ion pump.

Since the first voltage and the second voltage have opposed polarities, the ion pump will be in an operating mode only when the voltage polarity allows the generation of an electron plasma between the electrodes. In this configuration, a first overall current will include both the operating current and the leakage current. On the other hand, a second overall current measured when the voltage polarity is reversed (i.e. when the voltage polarity does not allow the generation of an electron plasma between the electrodes and the ion pump is in non-operating mode) will only include the leakage current. The operating current can therefore be obtained by comparing the first overall current and the second overall current and utilizing this comparison for the calculation of the pressure, thus allowing a very accurate determination thereof.

Accordingly, in an embodiment, the controller unit of the pumping system advantageously includes a processing unit suitable for calculating the operating current from the comparison of the first and second overall currents and for further calculating the pressure starting from the operating current thus obtained.

The measurement of the leakage current itself also involves additional advantages, as it can be utilized for obtaining essential information about the state of the pumping system (wear, possible malfunctioning, and the like).

In an embodiment, a method for operating a pumping system including an ion pump, comprising a first electrode and a second electrode, may correspondingly include:

applying a first voltage having a first polarity between the first electrode and the second electrode; and further

applying a second voltage having a second polarity, opposed to the first polarity, between the first electrode and the second electrode.

In an embodiment, the method further comprises:

measuring a first overall current supplied to the ion pump while the first voltage is applied between the first electrode and the second electrode; and

measuring a second overall current supplied to the ion pump while the second voltage is applied between the first electrode and the second electrode.

The overall current having the lower value between the first and second overall currents corresponds to the leakage current, while the operating current corresponds to the absolute value of the difference between the first and second overall currents. The method may therefore comprise calculating a pressure inside the ion pump starting from the operating current thus obtained.

As mentioned above, the pressure inside the ion pump is a function of the pump structure, the voltage applied between the electrodes, and the current absorbed by the ion pump. Accordingly, if during the operation of the pumping system the voltage applied to the electrodes is varied, a new measurement of the first and second overall currents is to be performed, in order to obtain the operating current and hence the pressure.

Other devices, apparatus, systems, methods, features and advantages of the invention will be or will become apparent to one with skill in the art upon examination of the following drawing figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following drawing figures. The components in the drawing figures are not necessarily to scale, emphasis instead being placed upon illustrating the principles of the present disclosure. In the drawing figures, like reference numerals designate corresponding parts throughout the different views.

FIG. 1 schematically shows a Penning trap.

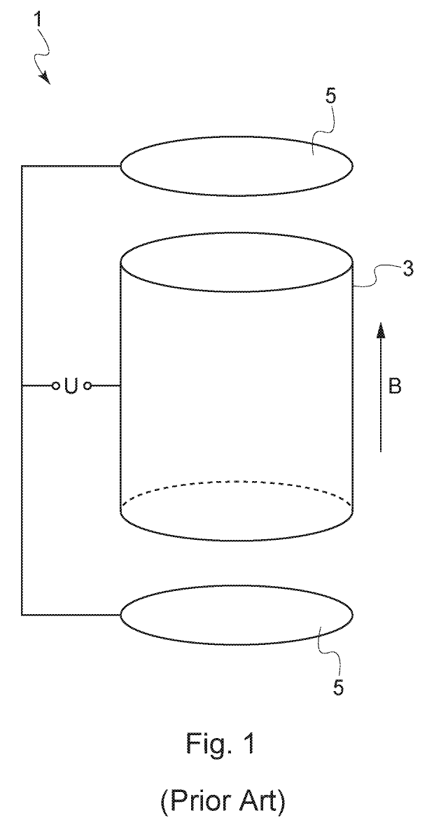

FIG. 2a schematically shows a pumping system according to a first execution example of an embodiment of the present disclosure.

FIG. 2b schematically shows a pumping system according to a second execution example of an embodiment of the present disclosure.

### DETAILED DESCRIPTION

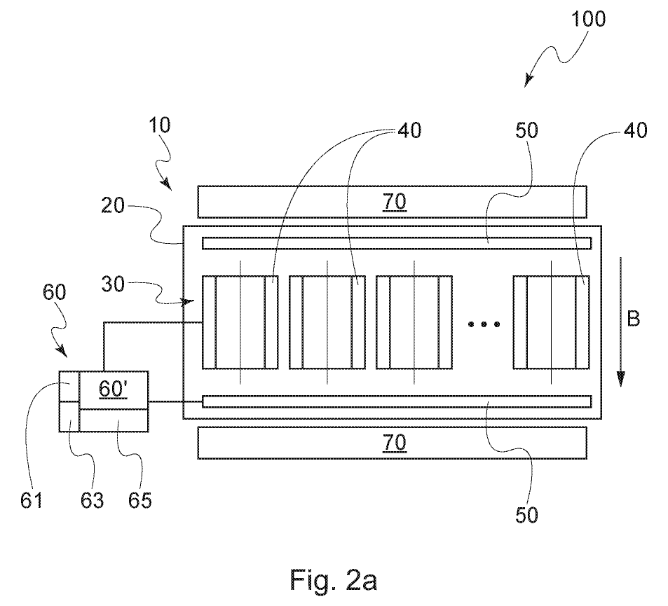

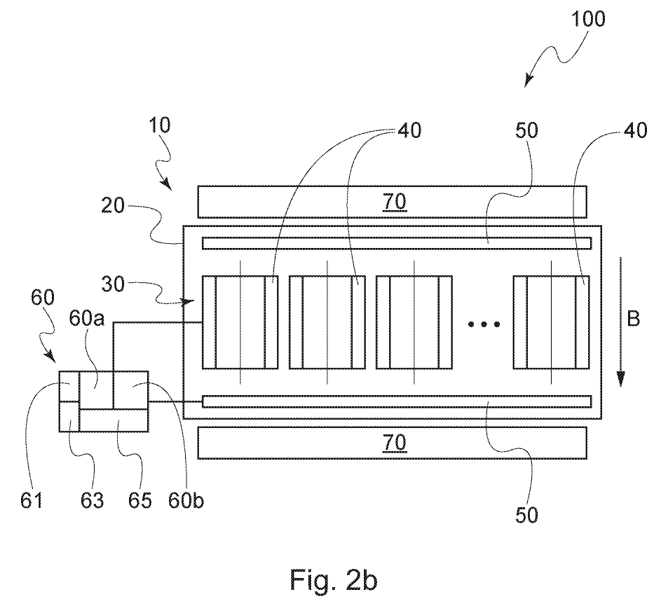

FIGS. 2a and 2b schematically show a pumping system 100 including a sputter ion pump 10. In the embodiment shown in FIGS. 2a and 2b, the design of the sputter ion pump 10 is based on the provision of a plurality of Penning traps; nevertheless, such design shall not be considered as limiting the scope of the present disclosure and other structures for the sputter ion pump can be envisaged.

The sputter ion pump 10 shown in FIGS. 2a and 2b comprises a vacuum enclosure 20 housing at least a first electrode 50 consisting of a pair of plates, arranged substantially parallel to each other and spaced apart from each other, and a second electrode 30 consisting of a plurality of hollow cells 40 arranged between the plates of the first electrode 50. More particularly, the hollow cells 40 are cylindrical cells with their longitudinal axes arranged in a substantially perpendicular direction with respect to the first electrode plates. The plates of the first electrode 50 are made of a getter material, such as titanium.

The sputter ion pump 10 further comprises magnets 70, located externally to the first electrode plates and outside of the vacuum enclosure 20, configured for producing a magnetic field oriented parallel to the axes of the second electrode cells 40.

The pumping system 100 further comprises a controller unit (or system controller, computing device, etc.) 60 configured for applying a voltage (potential difference) between the first and second electrodes 50,30. According to the shown embodiment of the present disclosure, the controller unit 60 is designed so as to selectively apply either a first voltage having a first polarity between the first electrode 50 and the second electrode 30, or a second voltage having a second polarity, opposed to the first polarity, between the first electrode 50 and the second electrode 30.

As appreciated by persons skilled in the art, the controller unit 60 may schematically represent one or more modules (or units, components, etc.) configured (or programmed) for controlling, monitoring and/or timing various functional aspects of the pumping system 100 including, for example, the operations of one or more components of (or communicating with) the sputter ion pump 10, as described herein. In the present context, the term “control” denotes wired or wireless communication with a given, controlled/controllable component. Depending on the type of component, such “control” may entail monitoring the operation of the component, timing the operation of the component, adjusting the operation of the component, sending control signals to the component, receiving output signals from the component (e.g., measurement or detection signals), and/or otherwise communicating with the component, as appreciated by the skilled artisan. As a further example, the controller unit 60 may be configured to apply a voltage between the first and second electrodes 50,30 in the sense that the controller unit 60 controls one or more voltage sources (i.e., appropriate electrical/electronic circuitry, powered by an appropriate power source) that may be electrically coupled to the first and second electrodes 50,30 (e.g., by setting, implementing, and/or adjusting magnitudes of voltage potentials applied, controlling the timing of operations of the voltage source(s), etc.), as appreciated by persons skilled in the art. Accordingly, the controller unit 60 illustrated in FIGS. 2a and 2b may be understood as schematically representing such voltage source(s), although in some implementations, the voltage source(s) may be located separately (or remotely) from the controller unit 60. All or part of the controller unit 60 (such as may be disposed in an electronics box) may be located directly at the sputter ion pump 10 or separately (or remotely) from the sputter ion pump 10. The controller unit 60 may be configured to control or perform one or more of the steps of any of the method implementations disclosed herein. For all such purposes, the controller unit 60 may include any suitable combination of hardware, firmware, software, etc., including one or more electronics-based processors and memories (e.g., the processing unit 65 illustrated in FIGS. 2a and 2b), as appreciated by persons skilled in the art. For example, the controller unit 60 may include a non- transitory (or tangible) computer-readable medium that includes non-transitory instructions stored thereon, that when executed on a processor, control or perform one or more of the steps of any of the method implementations disclosed herein. In FIGS. 2a and 2b, the schematically illustrated controller unit 60 is representative of all such components described in this paragraph that may be associated with the controller unit 60.

As appreciated by persons skilled in the art, one or more modules of the controller unit 60 may be, or be embodied in, one or more devices located outside or separate from the pumping system 100, for example, a computer workstation, desktop computer, laptop computer, portable computer, tablet computer, handheld computer, mobile computing device, personal digital assistant (PDA), smartphone, remote server, etc. One or more modules of the controller unit 60 may communicate with one or more other modules via one or more busses or other types of communication lines or wireless links, as appreciated by persons skilled in the art. In FIGS. 2a and 2b, the schematically illustrated controller unit 60 is representative of all such components described in this paragraph that may be associated with the controller unit 60.

As appreciated by persons skilled in the art, the processor(s) of the controller unit 60 may be representative of a main electronic processor providing overall control, and one or more electronic processors configured for dedicated control operations or specific signal processing tasks (e.g., a graphics processing unit or GPU, a digital signal processor or DSP, an application-specific integrated circuit or ASIC, a field-programmable gate array or FPGA, etc.). The memory or memories (e.g., volatile and/or non-volatile types, e.g., RAM and/or ROM) may be configured to store data and/or software. Stored data may be organized, for example, in one or more databases or look-up tables. The controller unit 60 may also include one or more device drivers for controlling one or more types of user interface devices and providing an interface between the user interface devices and components of the controller unit 60 communicating with the user interface devices. Such user interface devices may include user input devices (e.g., keyboard, keypad, touch screen, mouse, joystick, trackball, and the like) and user output devices (e.g., display screen, printer, visual indicators or alerts, audible indicators or alerts, and the like). In various implementations, the controller unit 60 may be considered as including one or more of the user input devices and/or user output devices, or at least as communicating with them. In FIGS. 2a and 2b, the schematically illustrated controller unit 60 is representative of all such components described in this paragraph that may be associated with the controller unit 60.

As appreciated by persons skilled in the art, in some implementations, the controller unit 60 may also include one or more types of computer programs or software contained in the memory (or memories) and/or on one or more types of non-transitory (or tangible) computer-readable media. One or more devices of the controller unit 60 may be configured to receive and read (and optionally write to) the memory (or memories) and/or computer-readable media. The computer programs or software may contain non-transitory instructions (e.g., logic instructions) for controlling or performing various operations of the pumping system 100, such as the operations of the various devices described herein. The computer programs or software may include system software and application software. System software may include an operating system (e.g., a Microsoft Windows® operating system) for controlling and managing various functions of the controller unit 60, including interaction between hardware and application software. In particular, the operating system may provide a graphical user interface (GUI) displayable via a user output device of the controller unit 60, and with which a user may interact with the use of a user input device of the controller unit 60. Application software may include software configured to control or execute various operations of the pumping system 100, and/or some or all of the steps of any of the methods disclosed herein. In FIGS. 2a and 2b, the schematically illustrated controller unit 60 is representative of all such components described in this paragraph that may be associated with the controller unit 60.

As appreciated by persons skilled in the art, the controller unit 60 may also include an ion pump controller (or control module) configured to control the operation of one or more components of the sputter ion pump 10 (e.g., on/off states, power supplied, etc.). The controller unit 60 may also include one or more sensor interfaces configured to receive and process feedback (e.g., measurement) signals received from one or more sensors/meters/data loggers provided with the sputter ion pump 10, such as the electrical current sensor (e.g., the current sensor 63 illustrated in FIGS. 2a and 2b) and voltage source(s) described herein. For example, the sensor interfaces may be embodied in different pieces of firmware or other electronic circuitry that are part of a microcontroller of the controller unit 60. The sensor interfaces may communicate with the ion pump controller and other components of the controller unit 60 as needed to provide effective control of various operations of the sputter ion pump 10 and/or the performance of any of the methods described herein. The firmware or other electronic circuitry embodying the ion pump controller also may be provided with the same microcontroller that includes the sensor interfaces, or the firmware or other electronic circuitry may be provided with separate hardware of the sputter ion pump 10. The controller unit 60 may also include a data acquisition module (or DAQ) configured to further condition or process the signals received by the sensor interface(s) as needed for preparing data to be analyzed by the controller unit 60. In FIGS. 2a and 2b, the schematically illustrated controller unit 60 is representative of all such components described in this paragraph that may be associated with the controller unit 60.

By way of non-limiting example, according to the execution example shown in FIG. 2a, the controller unit 60 includes a single controller 60’ that has a first operating mode in which the first voltage having the first polarity is applied between the first electrode 50 and the second electrode 30, and a second operating mode in which the second voltage having the second polarity, opposed to the first polarity, is applied between the first electrode 50 and the second electrode 30. The controller unit 60 is further provided with a piloting unit 61 configured for selectively making the single controller 60’ work in the first operating mode or in the second operating mode.

By way of further non-limiting example, according to the execution example shown in FIG. 2b, the controller unit 60 includes a first controller 60a designed to apply the first voltage having the first polarity between the first electrode 50 and the second electrode 30, and a second controller 60b designed to apply the second voltage having the second polarity, opposed to the first polarity, between the first electrode 50 and the second electrode 30. The controller unit 60 is further provided with a piloting unit 61 configured for selectively connecting either the first controller 60a or the second controller 60b to the sputter ion pump 10.

With reference to both execution examples of FIGS. 2a and 2b, assuming that when the first voltage with the first polarity is applied the second electrode 30 is at a higher potential than the first electrode 50, the first electrode 50 will serve as the cathode and the second electrode 30 will serve as the anode. In this configuration, the sputter ion pump 10 is in an operating mode. If a sufficiently high voltage is applied between the electrodes (typically, 3 to 9 kV), a strong electric field region is generated between the cells 40 of the second electrode 30 (anode) and the plates of the first electrode 50 (cathode), resulting in generation of an electric discharge. The electrons then collide with gas molecules inside the cells 40, thus ionizing them. Due to the electric field, the resulting positive ions are attracted by the plates of the first electrode 50 and collide with the surfaces thereof. Ion collisions with the titanium plates forming the first electrode plates result in the "sputtering" phenomenon, that is, the emission of titanium atoms from the plates of the first electrode 50.

The presence of magnets 70 for generating a magnetic field B allows for imparting helical trajectories to electrons, so as to increase the lengths of their paths between the electrodes 50,30 and, consequently, the chances of colliding with gas molecules inside the cells 40 and ionizing such molecules.

The controller unit 60 is provided with a current sensor 63 configured for detecting the overall current supplied to the sputter ion pump 10. In this configuration, a first overall current measured by the current sensor 63 includes an operating current contributing to the pumping effect as well as a leakage current.

Starting from the above assumption, when the piloting unit 61 of the controller unit 60 is triggered and the second voltage with the second polarity is applied, the first electrode 50 will be at a higher potential than the second electrode 30. When the plates of the first electrode 50 serve as the anode and the cells of the second electrode 30 serve as the cathode, no electron plasma is generated inside the sputter ion pump 10. Thus, the sputter ion pump 10 is in a non-operating mode. In this configuration, a second overall current measured by the current sensor 63 includes the leakage current only.

The controller unit 60 is further provided with a processing unit 65 configured to compare the first overall current and the second overall current. By comparing the overall currents, the processing unit 65 can isolate the operating current as the difference between the first overall current and the second overall current.

It is evident that if the above assumption were reversed, so that the sputter ion pump 10 were in a non-operating mode when the first potential is applied and in an operating mode when the second potential is applied, the difference between the first overall current and the second overall current would have a negative value. Therefore, in general, it can be said that the operating current corresponds to the absolute value of the difference between the first overall current and the second overall current. On the other hand, the leakage current corresponds to the overall current having the lower value between the first overall current and the second overall current. For example, if the value of the second overall current is lower than the value of the first overall current, then the second overall current corresponds to the leakage current.

It is worth mentioning that, in order to correctly determine the operating current and the leakage current, first and second voltages having the same absolute value but opposed polarities have to be applied.

Nevertheless, when the polarity of the applied voltage corresponds to the configuration in which the sputter ion pump 10 is in the non-operating mode, the power needed by the controller will be very low. Accordingly, it will not be necessary to provide a controller unit sized for supplying the same power both when applying the first voltage and when applying the second voltage.

With reference to the execution example of FIG. 2b, for instance, one of the controllers 60a,60b may be sized for supplying a power allowing to apply a proper voltage when the sputter ion pump 10 is in the operating mode, while the other one of the controllers 60a,60b may be sized so as to supply a much lower power (since it will be connected to the sputter ion pump 10 only when the latter is in the non-operating mode.

Analogously, with reference to the execution example of FIG. 2a, the single controller 60’ may not be sized for supplying the same power in both its operating modes.

Advantageously, the processing unit 65 of the controller unit 60 is further configured to calculate the pressure inside the sputter ion vacuum pump 10 starting from the operating current previously obtained. Such pressure is calculated according to known formulas including the voltage applied between the electrodes 50, 30 and the structural parameters of the sputter ion pump 10.

According to the shown embodiment, a method for operating the vacuum system 100 may include:

applying a first voltage having a first polarity between the first electrode 50 and the second electrode 30;

measuring a first overall current supplied to the sputter ion pump 10 while the first voltage is applied between the first electrode 50 and the second electrode 30;

applying a second voltage having a second polarity, opposed to the first polarity between the first electrode 50 and the second electrode 30;

measuring a second overall current supplied to the sputter ion pump 10 while the second voltage is applied between the first electrode 50 and the second electrode 30;

obtaining a leakage current as the overall current having the lower value between the first overall current and the second overall current;

obtaining an operating current as the absolute value of the difference between the first overall current and the second overall current;

calculating the pressure inside the sputter ion pump 10 starting from (based on) the operating current.

It will be understood that one or more of the processes, sub-processes, and process steps described herein may be performed by hardware, firmware, software, or a combination of two or more of the foregoing, on one or more electronic or digitally-controlled devices. The software may reside in a software memory in a suitable electronic processing component or system such as, for example, the controller unit 60 schematically depicted in FIGS. 2a and 2b. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module (which may be represented, e.g., by the processing unit 55 schematically depicted in FIGS. 2a and 2b). The processing module may include, for example, one or more microprocessors, general purpose processors, combinations of processors, digital signal processors (DSPs), application specific integrated circuits (ASICs), field-programmable gate array (FPGAs), etc. Further, the schematic diagrams in the drawing figures describe a logical division of functions having physical (hardware and/or software) implementations that are not limited by architecture or the physical layout of the functions. The examples of systems, apparatuses, devices, components, modules, or sub-modules described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the controller unit 60 schematically depicted in FIGS. 2a and 2b), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system (or apparatus, or device). A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” or “in electrical communication” as used herein means that two or more systems, devices, components, modules, or sub-modules are capable of communicating with each other via signals that travel over some type of signal path. The signals may be communication, power, data, or energy signals, which may communicate information, power, or energy from a first system, apparatus, device, component, module, or sub-module to a second system, apparatus, device, component, module, or sub-module along a signal path between the first and second systems, apparatuses, devices, components, modules, or sub-modules. The signal paths may include physical, electrical, magnetic, electromagnetic, electrochemical, optical, wired, or wireless connections. The signal paths may also include one or more additional systems, apparatuses, devices, components, modules, or sub-modules between the first and second systems, apparatuses, devices, components, modules, or sub-modules.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic, or fluidic relationship between two or more components or elements. As such, the fact that one component is said to communicate with a second component is not intended to exclude the possibility that additional components may be present between, and/or operatively associated or engaged with, the first and second components.

It will be evident to the person skilled in the art that the embodiments described above in detail should in no way be understood in a limiting sense, and that numerous modifications and variants are possible without thereby departing from the scope of protection as defined by the appended claims.

What is claimed is:

1. A pumping system, comprising:
an ion pump comprising a first electrode, a second electrode, and a controller unit for applying a voltage between the first electrode and the second electrode,
wherein the controller unit is configured to selectively apply either a first voltage having a first polarity between the first electrode and the second electrode, or a second voltage having a second polarity, opposed to the first polarity, between the first electrode and the second electrode.

2. The pumping system of claim 1, wherein the controller unit comprises a piloting unit configured to selectively apply either the first voltage having the first polarity between the first electrode and the second electrode, or the second voltage having the second polarity between the first electrode and the second electrode.

3. The pumping system of claim 1, wherein the controller unit comprises a current sensor configured to detect an overall current supplied to the ion pump when the first voltage or the second voltage is applied between the first electrode and the second electrode.

4. The pumping system of claim 3, wherein:
the current sensor is configured to detect a first overall current when the first voltage is applied between the first electrode and the second electrode, and to detect a second overall current when the second voltage is applied between the first electrode and the second electrode; and
the controller unit comprises a processing unit configured to compare the first overall current detected by the current sensor and the second overall current detected by the current sensor.

5. The pumping system of claim 4, wherein the processing unit is configured to calculate a first current or leakage current as the overall current having the lower value between the first overall current and the second overall current.

6. The pumping system of claim 4, wherein the processing unit is configured to calculate a second current or operating current as an absolute value of the difference between the first overall current and the second overall current.

7. The pumping system of claim 6, wherein the processing unit is configured to calculate a pressure inside the ion pump starting from the absolute value of the difference between the first overall current and the second overall current.

8. The pumping system of claim 1, wherein the controller unit comprises a single controller that has a first operating mode in which the single controller is configured to apply the first voltage having the first polarity between the first electrode and the second electrode, and a second operating mode in which the single controller is configured to apply the second voltage having the second polarity between the first electrode and the second electrode, and wherein the single controller is configured to selectively work either in the first operating mode or in the second operating mode.

9. The pumping system of claim 1, wherein the controller unit comprises a first controller configured to apply the first voltage having the first polarity between the first electrode and the second electrode, and a second controller configured to apply the second voltage having the second polarity between the first electrode and the second electrode, and wherein the controller unit is configured to selectively connect either the first controller or the second controller to the ion pump.

10. The pumping system of claim 1, wherein the ion pump is a sputter ion pump.

11. The pumping system of claim 1, wherein the first electrode comprises a pair of plates, arranged substantially parallel to each other and spaced apart from each other, and the second electrode comprises a plurality of hollow cells arranged between the plates of the first electrode.

12. The pumping system of claim 11, wherein the hollow cells are cylindrical cells with their longitudinal axes arranged in a substantially perpendicular direction with respect to the plates of the first electrode.

13. A method for operating a pumping system, the method comprising:
providing the pumping system, wherein the pumping system comprises an ion pump, and the ion pump comprises a first electrode, a second electrode, and a controller unit; and
operating the controller unit to control an operation comprising:
selectively applying a first voltage having a first polarity between the first electrode and the second electrode; and
selectively applying a second voltage having a second polarity, opposed to the first polarity, between the first electrode and the second electrode.

14. The method of claim 13, further comprising measuring a first overall current supplied to the ion pump while the first voltage is applied between the first electrode and the second electrode, and measuring a second overall current supplied to the ion pump while the second voltage is applied between the first electrode and the second electrode.

15. The method of claim 14, further comprising obtaining a first current or leakage current as the overall current having the lower value between the first overall current and the second overall current.

16. The method of claim 14, further comprising obtaining a second current or operating current as an absolute value of the difference between the first overall current and the second overall current.

17. The method of claim 16, further comprising calculating a pressure inside the ion pump starting from the absolute value of the difference between the first overall current and the second overall current.

18. The method of claim 13, further comprising measuring a second overall current supplied to the ion pump while the second voltage is applied between the first electrode and the second electrode, the ion pump being in a non-operating mode upon application of the second voltage.

19. The method of claim 13, comprising applying the first voltage having the first polarity between the first electrode and the second electrode, wherein the ion pump is in an operating mode upon application of the first voltage, and subsequently applying the second voltage having the second polarity between the first electrode and the second electrode.

20. The method of claim 13, wherein the ion pump is a sputter ion pump.
